(19) United States
(12) Patent Application Publication
(10) Pub. No.: US 2015/0131330 A1
(43) Pub. Date: May 14, 2015

(54) BIDIRECTIONAL DC-DC CONVERTER SYSTEM AND CIRCUIT THEREOF

(71) Applicant: National Tsing Hua University, Hsinchu (TW)

(72) Inventors: Ching-Tsai PAN, Hsinchu (TW); Chen-Feng CHUANG, Hsinchu (TW)

(73) Assignee: National Tsing Hua University, Hsinchu (TW)

(21) Appl. No.: 14/228,816

(22) Filed: Mar. 28, 2014

(30) Foreign Application Priority Data
Nov. 14, 2013 (TW) 102141533

(51) Int. Cl. H02M 3/335

(52) U.S. Cl. CPC H02M 3/33507
USPC 363/17

(57) ABSTRACT

The invention discloses a bidirectional dc-dc converter system and circuit thereof. In boost mode, topology is combined with interleaved two-phase boost converter for providing a higher step-up voltage gain. In buck mode, topology is combined with interleaved two-phase buck converter in order to get a higher step-down conversion ratio. The main objectives of the invention are aimed to both store energy in the blocking capacitors (C1&C2) for increasing voltage conversion ratio and reduce voltage stresses of active switches simultaneously. As a result, the invention topology possesses a nice low switch voltage stress characteristic. This will allow one to choose lower voltage rating MOSFETs to reduce both switching and conduction losses, and overall efficiency can be enhanced. In addition, due to charge balance of the blocking capacitor, the converter features both automatic uniform current sharing characteristic of interleaved phases and without adding extra circuitry or using complex control methods.

### CROSS-REFERENCE TO RELATED APPLICATION

This application claims the benefit of Taiwan Patent Application No. 102141533, filed on Nov. 14, 2013, in the Taiwan Intellectual Property Office, the disclosure of which is incorporated herein its entirety by reference.

### BACKGROUND OF THE INVENTION

1. Field of the Invention

The present invention generally relates to a novel isolated interleaved bidirectional DC-DC converter with low switch voltage stress characteristic for the low-voltage distributed energy resource applications, in particular with respect to a bidirectional dc-dc converter system and circuit thereof with bidirectional high conversion ratio and high efficiency.

2. Description of the Related Art

Recently bidirectional dc-dc converters (BDC) have received a lot of attention due to the increasing need to systems with the capability of bidirectional energy transfer between two dc buses. Apart from traditional application in dc motor drives, new applications of BDC include energy storage in renewable energy systems, fuel cell energy systems, hybrid electric vehicles (HEV) and uninterruptible power supplies, PV hybrid power systems, and battery chargers.

Various BDCs can be divided into the non-isolated BDCs and isolated BDCs. In a variety of different isolated BDCs, the bidirectional DC-DC flyback converters are more attractive due to simple structure and easy control. However, these converters suffer from high voltage stresses on the power devices due to the leakage-inductor energy of the transformer. In order to recycle the leakage inductor energy and to minimize the voltage stress on the power devices, the active clamp circuit is proposed in bidirectional converter. However, the number of switches is also added. Recently, a novel soft-commutating isolated boost full-bridge ZVS-PWM DC-DC converter is proposed. Soft switching techniques can reduce switching losses. However, due to the bidirectional characteristic of BDCs, using two auxiliary switches is inevitable which results in extra cost and complexity of the control circuit.

Some literatures research the isolated bidirectional DC-DC converters, which include the half-bridge types and full-bridge types. These converters can provide high step-up and step-down voltage gain by adjusting the turns ratio of the transformer. The number of switches is usually between four and eight. Also, some isolated bidirectional converters are characterized by a current-fed rectifier on the low-voltage (LV) side and a voltage-fed rectifier on the high-voltage (HV) side.

### SUMMARY OF THE INVENTION

The aspect of the embodiment of present invention directs to a novel interleaved high conversion ratio bidirectional dc-dc converter with low switch voltage stress is proposed. In boost mode, the module topology is combined with interleaved two-phase boost converter for providing a much higher step-up voltage gain without adopting an extreme large duty ratio. In buck mode, the module topology is combined with interleaved two-phase buck converter in order to get a high step-down conversion ratio without adopting an extreme short duty ratio. Based on the capacitive voltage division, the main objectives of the bidirectional dc-dc converter are aimed to store energy in the blocking capacitors for increasing the voltage conversion ratio and reducing voltage stresses of active switches simultaneously. As a result, the bidirectional dc-dc converter possesses a nice low switch voltage stress characteristic. This will allow one to choose lower voltage rating MOSFETs to reduce both switching and conducting losses, and the overall efficiency can be consequently enhanced. In addition, due to charge balance of the blocking capacitor, the converter features both automatic uniform current sharing characteristic of the interleaved phases and without adding extra circuitry or using complex control methods. In addition, the invention can provide high step-up and step-down voltage gain by adjusting the turns ratio of the transformer. For higher power applications, more modules topology can be combined with input parallel/output series connection to increase the power rating and reduce the input and output ripples.

In accordance with the aforementioned purpose, the present invention provides a two phase interleaved isolation bidirectional dc-dc converter (IBDC) system comprising a first circuit, a switched capacitor circuit, and a transformer. The first circuit has a first inductor, a second inductor, a first switch, and a second switch. The switched capacitor circuit has a first capacitor, a second capacitor, a third capacitor, a fourth capacitor, a first operating switch, a second operating switch, a third operating switch, and a fourth operating switch. The first operating switch and the fourth operating switch are driven complementarily with the first switch, the second operating switch and the third operating switch are driven complementarily with the second switch and the phase shift between two phases is 180°. The transformer electrically couples with the first circuit and the switched capacitor circuit, and transfers electric power between the first circuit and the switched capacitor circuit. When the first circuit is supplied with a low voltage (V_{L}), the first switch and the second switch is operated boost mode, the stored energy in inductors via the transformer is discharged to the switched capacitor circuit and output load and utilizes voltage multiplier concept to increase the step-up conversion ratio, and further reduce the switch across voltage. When the switched capacitor circuit is supplied with the high voltage (V_{H}), the first operating switch, the second operating switch, the third operating switch, and fourth operation switch is operated buck mode, the stored energy in the switched capacitor circuit via the transformer is discharged to inductors and output load of first circuit and utilizes voltage divider concept to increase the step-down conversion ratio, and further reduce the switch across voltage. The present invention utilizes voltage multiplier and voltage divider concept of the capacitor to increase the conversion ratio for boost or buck, and further reduce the voltage stress of active switches. In addition, the invention converters can provide high step-up and step-down voltage conversion ratio by adjusting the turns ratio of the transformer. Therefore, the circuit topology can use the elements with lower voltage rating in order to reduce the switching loss and conduction loss to increase the conversion efficiency of the converter.

Preferably, the first switch, the second switch, the first operating switch, the second operating switch, the third operating switch, or the fourth operating switch may comprise a parallel connection of a silicon control rectifier and a Schottky diode.

Preferably, the conduction duration of the first switch, the second switch, the first operating switch, the second operating switch, the third operating switch, or the fourth operating switch directly affects output power of the bidirectional dc-dc converter system.

Preferably, a capacitance value of the first capacitor, the second capacitor, the third capacitor, or the fourth capacitor and an inductor value of the first inductor or the second inductor mainly determine a time constant of circuit operation in the boost mode or the buck mode.

Preferably, the first operating switch and the fourth operating switch are driven complementarily with the first switch by an inverter logical gate. The second operating switch and the third operating switch are driven complementarily with the second switch by an inverter logical gate.

In view of the aforementioned purpose, the present invention further provides a two phase interleaved IBDC converter circuit comprising a first circuit, switched capacitor circuit and a transformer. The first circuit has a first inductor element, a second inductor element, a first device, a first switch element, a second switch element, a first electrical node, a second electrical node, a third electrical node, and a fourth electrical node. An end of the first inductor element, an end of the second inductor element, and an end of the first device are electrically coupled to the first electrical node, an end of the first switch element, an end of the second switch element, and the other end of the first device are electrically coupled to the second electrical node, the other end of the first inductor element, the other end of the first switch element are electrically coupled to the third electrical node, the other end of the second inductor element and the other end of the second switch element are electrically coupled to the fourth electrical node. The switched capacitor circuit comprises a first operating switch element, a second operating switch element, a third operating switch element, a fourth operating switch, a first capacitor element, a second capacitor element, a third capacitor element, a fourth capacitor element, a fifth electrical node, a sixth electrical node, a seventh electrical node, an eighth electrical node, a ninth electrical node, a tenth electrical node, an eleventh electrical node, and a second device. An end of the first operating switch element, an end of the first capacitor element, and an end of the third operating switch element are electrically coupled to the fifth electrical node, an end of the second operating switch element, an end of the second capacitor element, and an end of the fourth operating switch element are electrically coupled to the sixth electrical node, the other end of the first operating switch element, and the other end of the second operating switch element are electrically coupled to the eleventh electrical node, the other end of the third operating switch element, an end of the third capacitor element, and an end of the second device are electrically coupled to the seventh electrical node, the other end of the fourth operating switch element, an end of the fourth capacitor element, and the other end of the second device are electrically coupled to the eighth electrical node, the other end of the first capacitor element, and the other end of the second capacitor element are electrically coupled to the ninth electrical node, the other end of the third capacitor element and the other end of the fourth capacitor element are electrically coupled to the tenth electrical node, the tenth electrical node is electrically coupled to the eleventh electrical node. The transformer has a primary side electrically coupled to the first circuit and a secondary side electrically coupled to the switched capacitor circuit. The end of the primary side is electrically coupled to the third electrical node, the other end of the secondary side is electrically coupled to the fourth electrical node, an end of the secondary side is electrically coupled to the eleventh electrical node, and the other end of the secondary side is electrically coupled to the ninth electrical node.

Preferably, for higher voltage conversion and higher power applications purpose, the bidirectional dc-dc converter circuit can be modularized and extended topology by using input parallel/output series techniques to increase the power rating, high conversion ratio and reduce the input and output ripples.

Preferably, when the first device is supplied with a lower voltage, operating a boost mode, the IBDC converter circuit through the combination of interleaved controlling the first switch element and the second switch element, so that the first inductor element, the second inductor element, the first capacitor element, the second capacitor element, the third capacitor element, or the fourth capacitor element supplies energy to the second device to generate a step-up effect.

Preferably, when the second device is supplied with a high voltage (V_{H}), entering a buck mode, the IBDC converter circuit through the combination of interleaved controlling the first switch element and the second switch element, so that the first inductor element, the second inductor element, the first capacitor element, the second capacitor, the third capacitor element, or the fourth capacitor element supplies energy to the first device to generate a step-down effect.

Preferably, the first switch element is complementally driven with the first operating switch element and the fourth operating switch element by an inverter logical gate. The second switch element is complementally driven with the second operating switch element and the third operating switch element by an inverter logical gate.

### BRIEF DESCRIPTION OF THE DRAWINGS

The drawings and description are to be regarded as illustrative in nature and not restrictive. Like reference numerals designate like elements throughout the specification, wherein:

FIG. 1 is a block diagram of a bidirectional dc-dc converter system according to an embodiment of the present invention;

FIG. 2 is an equivalent circuit of the interleaved bidirectional DC-DC converter showing mode 1 and mode 3 under the step-up mode of the present invention;

FIG. 3 is an equivalent circuit of the interleaved bidirectional DC-DC converter showing mode 2 under the step-up mode of the present invention;

FIG. 4 is an equivalent circuit of the interleaved bidirectional DC-DC converter showing mode 4 under the step-up mode of the present invention;

FIG. 5 is the key waveforms in different modes under the step-up mode of the interleaved bidirectional DC-DC converter of the present invention;

FIG. 6 is an equivalent circuit of the interleaved bidirectional DC-DC converter showing mode 1 under the step-down mode of the present invention;

FIG. 7 is an equivalent circuit of the interleaved bidirectional DC-DC converter showing mode 2 and 4 under the step-down mode of the present invention;

FIG. 8 is an equivalent circuit of the interleaved bidirectional DC-DC converter showing mode 3 under the step-down mode of the present invention;

FIG. 9 is the key waveforms in different modes under the step-down mode of the interleaved bidirectional DC-DC converter of the present invention;

FIG. 10a is the basic configuration of a novel two-phase interleaved bidirectional converter of the present invention; and

FIG. 10b is the generalized configuration using module units for higher bidirectional conversion application of the present invention.

### DETAILED DESCRIPTION OF THE PREFERRED EMBODIMENTS

As used herein, the term “and/or” includes any and all combinations of one or more of the associated listed items. Expressions such as “at least one of,” when preceding a list of elements, modify the entire list of elements and do not modify the individual elements of the list.

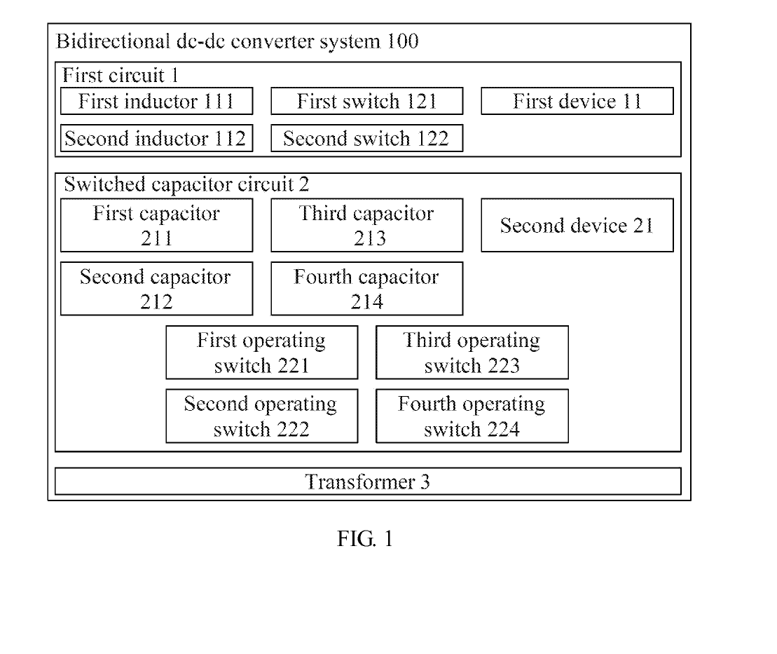

With reference to FIG. 1 for a block diagram of a bidirectional dc-dc converter system according to an embodiment of the present invention. As shown in FIG. 1, the bidirectional dc-dc converter system 100 comprises a first circuit 1, a switched capacitor circuit 2, and a transformer 3. The first circuit 1 comprises a first device 11, a first inductor 111, a second inductor 112, a first switch 121, and a second switch 122, wherein the first device 11 may comprise an input voltage or an output load, the first switch 121 and the second switch 122 are used to control the power flow of the first circuit 1, and the first inductor 111 and the second inductor 112 are used to store energy as a tank storage.

The switched capacitor circuit 2 comprises a second device 21, a first capacitor 211, a second capacitor 212, a third capacitor 213, a fourth capacitor 214, a first operating switch 221, a second operating switch 222, a third operating switch 223, and a fourth operating switch 224, wherein the four operating switches are used to control the power flow of the switched capacitor circuit 2, and the first switch 121 in the first circuit 1 is driven complementarily with the operating switches by an inverter logical gate, for example, when the first switch 121 is turned on, the first operating switch 221 and the fourth operating switch 224 are turned off.

The transformer 3 is electrically coupled to the first circuit 1 and the switched capacitor circuit 2, and transfers electric power between the first circuit 1 and the switched capacitor circuit 2.

In boost operating mode, the first device 11 is applied with a lower voltage and the second device 21 is connected a resistor loading. The power energy is transferred from the first device 11 to the second device 21 at this moment. In boost operating mode, the first circuit 1 is as a current multiplier and the switched capacitor circuit 2 is as a voltage multiplier. As a result, the invention converter can increase the boost voltage conversion ratio and reducing voltage stresses of active switches simultaneously. On the other hand, in buck operating mode, the second device 21 is applied with a high voltage (V_{H}) and the first device 11 is connected a resistor loading R with capacitor C_{O}. The power energy is transferred from the second device 21 to the first device 11 at this moment. In buck operating mode, the switched capacitor circuit 2 is as a voltage divider and the first circuit 1 is as a current multiplier. As a result, the invention converter can increase the step-down voltage conversion ratio and reducing voltage stresses of active switches simultaneously. In addition, the invention can provide high step-up and step-down voltage gain by adjusting the turns ratio of the transformer 3. In invention converter, the capacitor values of the four capacitors or inductor values of the two inductors determine a time constant of circuit action in the boost mode or the buck mode.

By means of the present invention, it can not only increase the voltage conversion ratio, but also share the voltage stress of the first switch 121 and the second switch 122. This will allow one to choose lower voltage rating MOSFETs to reduce both switching and conduction losses, and the overall efficiency can be consequently enhanced. Moreover, due to charge balance of the blocking capacitor, the bidirectional dc-dc converter system 100 features both automatic uniform current sharing characteristic of the interleaved phases and without adding extra circuitry or using complex control methods.

Wherein the first switch 121, the second switch 122, the first operating switch 221, the second operating switch 222, the third operating switch 223, or the fourth operating switch 224 comprises a parallel connection of a silicon control rectifier and a Schottky diode, and the voltage conversion ratio of the bidirectional dc-dc converter system 100 is affected by the duty ratio of the two switches or the four operating switches.

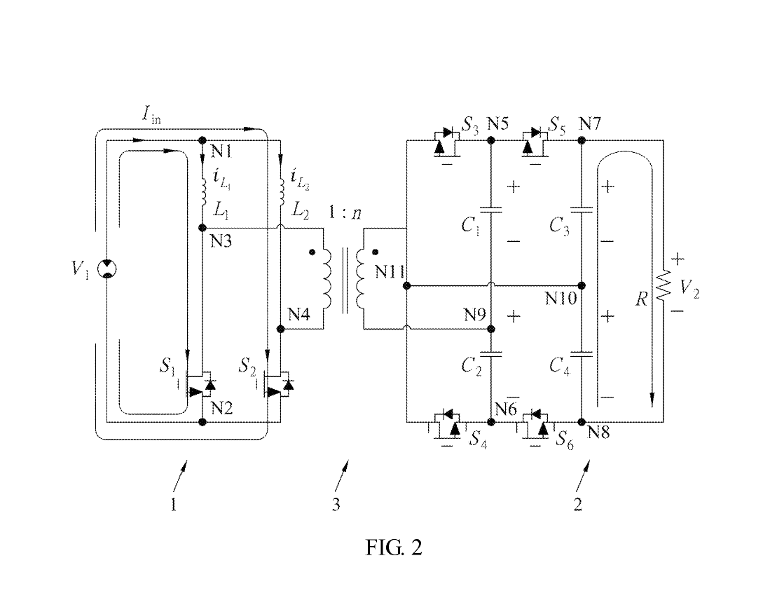

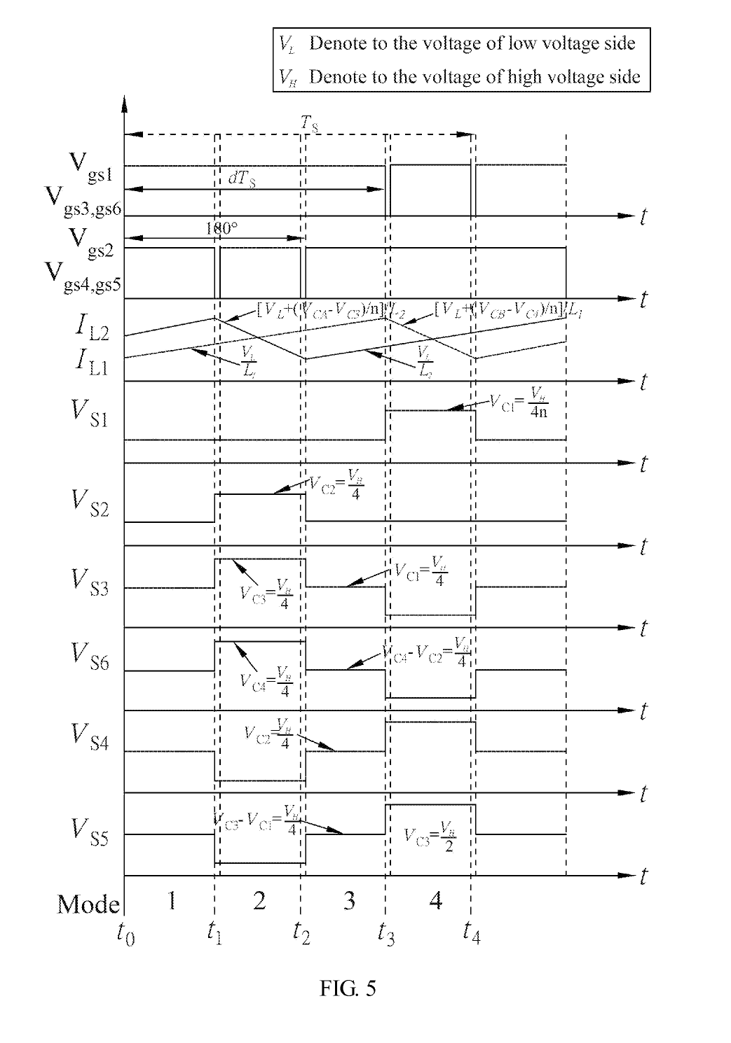

In step-up mode of the interleaved bidirectional DC-DC converter of the present invention, the key waveforms in different operating modes of invention bidirectional DC-DC converter is shown in FIG. 5. In mode 1 and mode 3, the first switch 121 and the second switch 122 are turned on, and the first operating switch 221, the second operating switch 222, the third operating switch 223, and the fourth operating switch 224 are turned off. Then, the corresponding equivalent circuits are shown in FIG. 2. The bidirectional dc-dc converter circuit comprises a first circuit 1, a switched capacitor circuit 2, and a transformer 3, wherein an end of a first inductor element L1, an end of a second inductor element L2, and an end of a first device V1 (with low voltage source) are electrically coupled to a first electrical node N1, an end of a first switch element S1, an end of a second switch element S2, and the other end of the first device V1 are electrically coupled to a second electrical node N2, the other end of the first inductor element L1 and the other end of the first switch element S1 are electrically coupled to a third electrical node N3, the other end of the second inductor element L2 and the other end of the second switch element S2 are electrically coupled to a fourth electrical node N4.

In the switched capacitor circuit 2, an end of the first operating switch element S3, an end of the first capacitor element C1, and an end of the third operating switch element S5 are electrically coupled to a fifth electrical node N5, an end of the second operating switch element S4, an end of the second capacitor element C2, and an end of the fourth operating switch element S6 are electrically coupled to a sixth electrical node N6, the other end of the first operating switch element S3 and the other end of the second operating switch element S4 are electrically coupled to an eleventh electrical node N11, the other end of the third operating switch element S5, an end of the third capacitor element C3 and an end of the second device V2 (with a resistor loading R) are electrically coupled to a seventh electrical node N7, the other end of the fourth operating switch element S6, an end of the fourth capacitor element C4, and the other end of the second device V2 are electrically coupled to an eighth electrical node N8, the other end of the first capacitor element C1 and the other end of the second capacitor element C2 are electrically coupled to a ninth electrical node N9, the other end of the third capacitor element C3 and the other end of the fourth capacitor element C4 are electrically coupled to a tenth electrical node N10, the tenth electrical node N10 is electrically coupled to the eleventh electrical node N11; and a transformer 3 having a primary side electrically coupled to the first circuit 1 and a secondary side electrically coupled to the switched capacitor circuit 2. An end of the primary side is electrically coupled to the third electrical node N3, the other end of the primary side is electrically coupled to the fourth electrical node N4, an end of the secondary side is electrically coupled to the eleventh electrical node N11, and the other end of the secondary side is electrically coupled to the ninth electrical node N9.

The first switch element S1 is driven complementally with the first operating switch element S3 and the fourth operating switch element S6 by an inverter logical gate; the second switch element S2 is driven complementally with the second operating switch element S4 and the third operating switch element S5 by an inverter logical gate. The phase shift between two phases is 180°.

The boost mode is performed when the first device V1 is applied with a low voltage (V_{L}). Prior to entering mode 1 of the step-up mode, the first operating switch element S3 and the fourth operating switch element S6 are turned off. The secondary current of the transformer 3 provides two separate currents paths flow through the body diodes of the first operating switch element S3 and the fourth operating switch element S6, and the inductor current i_{L2} flows through the second switch element S2.

The gating signals of the active switches for boost operation mode are shown in FIG. 5. The boost operation of the invention converter under steady state can be classified into four operation modes and switching signals of the first switch element S1, the second switch element S2, the first operating switch element S3, the second operating switch element S4, the third operating switch element S5, and the fourth operating switch element S6 are shown in FIG. 2 to FIG. 4, wherein Tₛ is switching period of the four operation modes. Prior to mode 1, the first operating switch element S3 and the fourth operating switch element S6 are off During dead time, the secondary current of the transformer would be forced to flow through the body diodes of the first operating switch element S3 and the fourth operating switch element S6 respectively. Also, inductor current i_{L2} flows through the switch the second switch element S2.

In mode 1, at t₀, the first switch element S1 is turned on, and the first operating switch element S3, the second operating switch element S4, the third operating switch element S5, and the fourth operating switch element S6 are turned off. The corresponding equivalent circuit is shown in FIG. 2. Then, the inductor current i_{L1} flows into the first switch element S1 and the inductor current i_{L2} flows into the second switch element S2. From FIG. 2, it is seen that both the inductor current i_{L1} and the inductor current i_{L2} are increasing to store energy in the first inductor element L1 and the second inductor element L2 respectively. The voltages across the first operating switch element S3 and the second operating switch element S4 are clamped to the voltage of the first capacitor element C1 and the voltage of the second capacitor element C2 respectively and the voltages across the fourth operating switch element S6 and the third operating switch element S5 are clamped to the voltage of the fourth capacitor element C4 minus the voltage of the second capacitor element C2 and the voltage of the third capacitor element C3 minus the voltage of the first capacitor element C1 respectively. Also, the power of the second device V2 is supplied from the third capacitor element C3 and the fourth capacitor element C4.

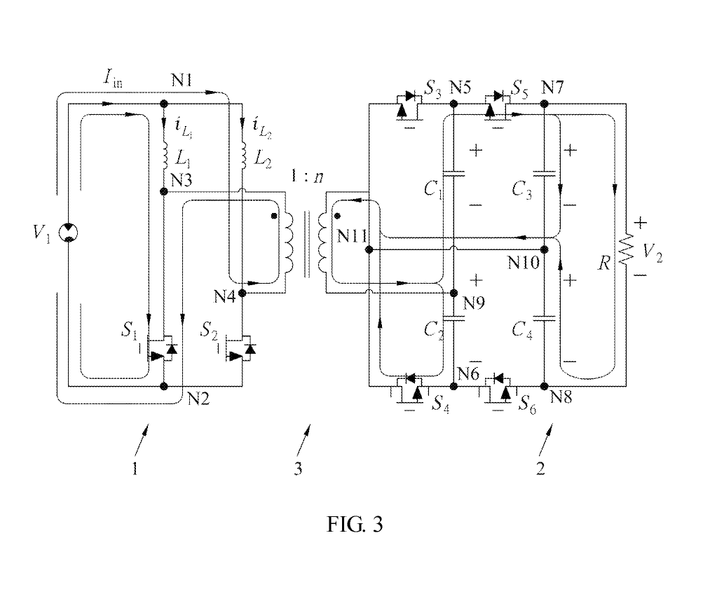

At t₁, the second switch element S2 is turned off After a short dead time, the second operating switch element S4 and the third operating switch element S5 are turned on while their body diodes are conducting so that the switches S4 and S5 can be turned on under zero-voltage condition. The corresponding equivalent circuit is shown in FIG. 3. During mode 2, part of stored energy in the second inductor element L2 via the transformer 3 as well as the stored energy of the first capacitor C1 is released to the third capacitor element C3 and the second device V2. Meanwhile, part of stored energy in the second inductor element L2 via the transformer 3 is stored in the second capacitor element C2. During this mode, inductor current i_{L1} increases continuously and inductor current i_{L2} decreases linearly.

At t₂, the second operating switch element S4 and the third operating switch element S5 are turned off. After a short dead time, the second switch element S2 is turned on. The corresponding equivalent circuit is shown in FIG. 2. In mode 3, the corresponding equivalent circuit turns out to be the same as mode 1, and thus, unnecessary details are no longer give hereinafter.

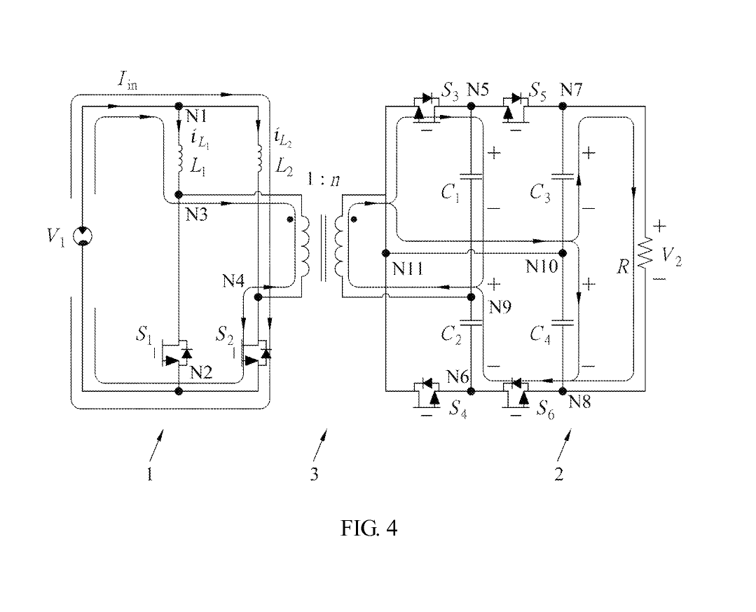

At t₃, the first switch element S1 is turned off After a short dead time, the first operating switch element S3 and the fourth operating switch element S6 are turned on while their body diodes are conducting so that the switches S3 and S6 can be turned on under zero-voltage condition. The corresponding equivalent circuit is shown in FIG. 4. During mode 4, part of stored energy in the first inductor element L1 via the transformer 3 as well as the stored energy of the second capacitor element C2 is released to the fourth capacitor element C4 and the second device V2. Meanwhile, part of stored energy in the first inductor element L1 via the transformer 3 is stored in the first capacitor element C1. During this mode, inductor current i_{L1} decreases continuously and inductor current i_{L2} increases linearly.

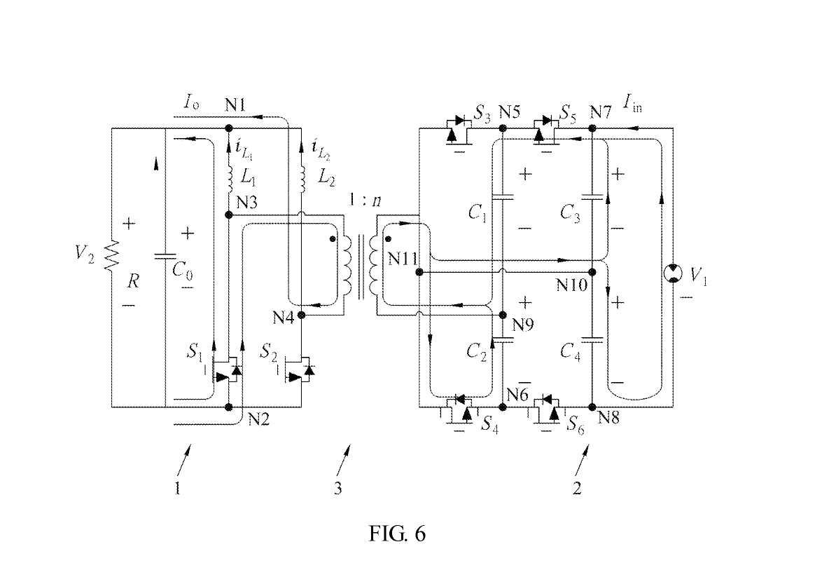

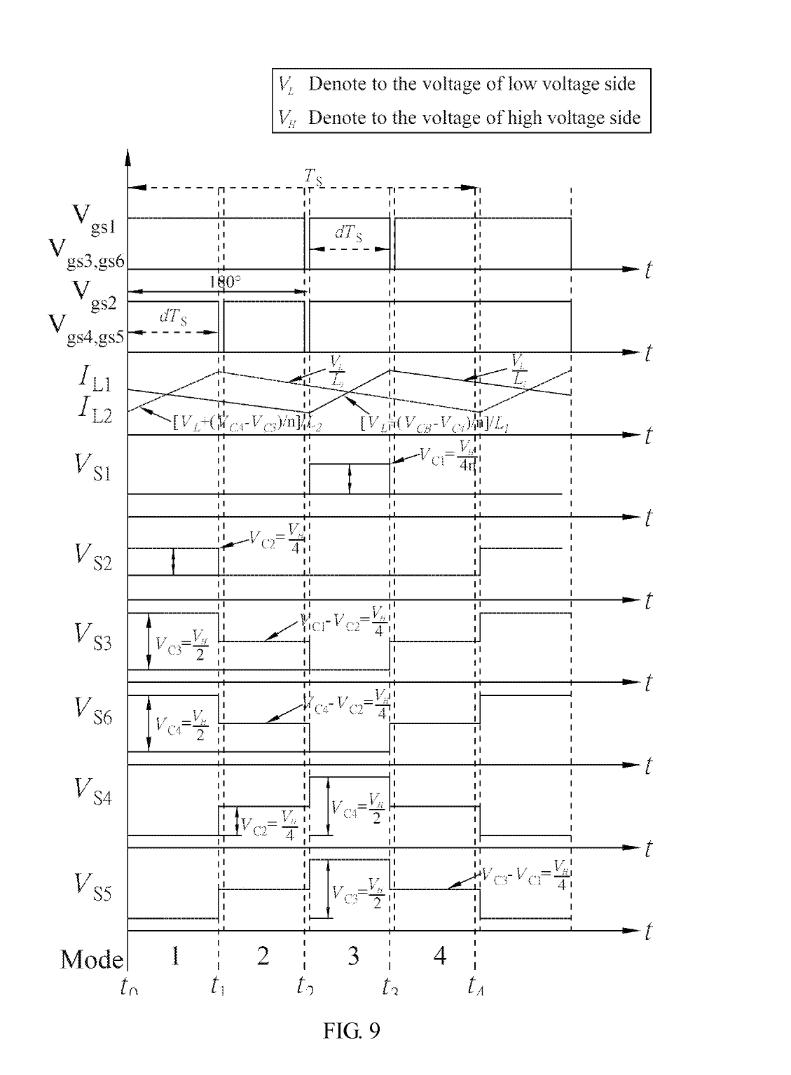

In the buck mode, the key waveforms in different operating modes of invention bidirectional DC-DC converter are shown in FIG. 9. The buck operation of the invention converter under steady state can be classified into four operation modes and the switching signals of the first switch element S1, the second switch element S2, the first operating switch element S3, the second operating switch element S4, the third operating switch element S5 and the fourth operating switch element S6 switching signals are shown in FIG. 6 to FIG. 8, wherein Tₛ is the switching period of the four operation modes.

In buck mode, a high voltage (V_{H}) is applied to the first device V1 of the switched capacitor circuit 2 (the input voltage device is set as first device V1) is shown in FIG. 6. Prior to entering mode 1 of the step-down mode, the second switch element S2 is turned off During the dead time, the inductor current i_{L1} flows through the first switch element S1, the inductor current i_{L2} flows the body diode of the second switch element S2.

At t₀, the second operating switch element S4 and the third operating switch element S5 are turned on. The current that had been flowing through the body diode of the second switch element S2 flows into the first switch element S1. The corresponding equivalent circuit is shown in FIG. 6. During mode 1, the inductor current i_{L1} is freewheeling through the first switch element S1 and the first inductor element L1 is releasing energy to the second device V2 (resistor loading R with capacitor C_{O}). One path of current starts from the third capacitor element C3, through the third operating switch element S5, the first capacitor element C1, the transformer 3, and then back to the third capacitor element C3 again. Hence, the stored energy of the third capacitor element C3 is discharged to the first capacitor element C1 as well as via the transformer 3 to the second inductor element L2 and the second device V2. Another path of current starts from the second capacitor element C2, the transformer 3, the second operating switch element S4, and then back to the second capacitor element C2 again. In other words, the stored energy of the second capacitor element C2 via the transformer 3 is discharged to the second inductor element L2 and the second device V2. Therefore, during this mode, the inductor current i_{L1} is decreasing and the inductor current i_{L2} is linearly increasing.

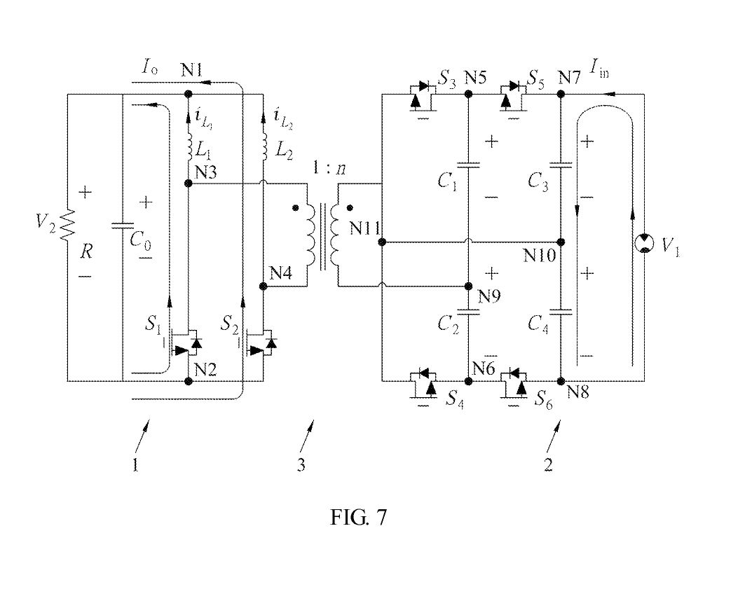

At t₁, the second operating switch element S4 and the third operating switch element S5 are turned off After a short dead time, the second switch element S2 is turned on while its body diode is conducting so that the switch S2 can be turned on under zero-voltage condition. The corresponding equivalent circuit is shown in FIG. 7. In mode 2, the inductor current i_{L1} and the inductor current i_{L2} are freewheeling through the first switch element S1 and the second switch element S2 respectively. Both the voltage of the first inductor element L1 and the voltage of the second inductor element L2 are equal to opposite voltage of the capacitor Cₒ, the inductor current i_{L1} and inductor current i_{L2} decrease linearly. The first inductor element L1 and the second inductor element L2 are releasing energy to the second device V2.

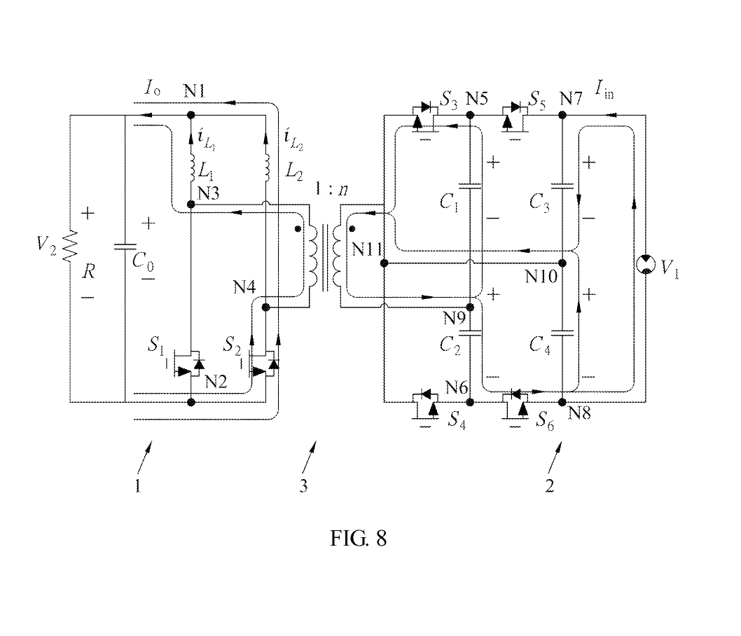

At t₂, the first switch element S1 is turned off and the inductor current i_{L1} flows through the body diode of the first switch element S1. After a short dead time, the first operating switch element S3 and the fourth operating switch element S6 are turned on. The corresponding equivalent circuit is shown in FIG. 8. The current that had been flowing through the body diode of the first switch element S1 flows into the second switch element S2. During mode 3, the inductor current i_{L2} freewheels through the first switch element S2 and the second inductor element L2 is releasing energy to the second device V2. One path of current starts from the fourth capacitor element C4, through the transformer 3, the second capacitor element C2, the fourth operating switch element S6, and then back to the fourth capacitor element C4 again. Hence, the stored energy of the fourth capacitor element C4 is discharged to the second capacitor element C2 as well as via the transformer 3 to the first inductor element L1 and the second device V2. Another path of current starts from the first capacitor element C1, the first operating switch element S3, the transformer 3, and then back to the first capacitor element C1 again. In others words, the stored energy of the first capacitor element C1 via the transformer 3 is discharged to the first inductor element L1 and the second device V2. Therefore, during this mode, the inductor current i_{L1} increases linearly and the inductor current i_{L2} decreases.

At t₃, the first operating switch element S3 and the fourth operating switch element S6 are turned off After a short dead time, the first switch element S1 is turned on while its body diode is conducting so that the switch S1 can be turned on under zero-voltage condition. The corresponding equivalent circuit is shown in FIG. 7. The corresponding equivalent circuit turns out to be the same as FIG. 7 and its operation is the same as that of mode 2, and thus, unnecessary details are no longer give hereinafter.

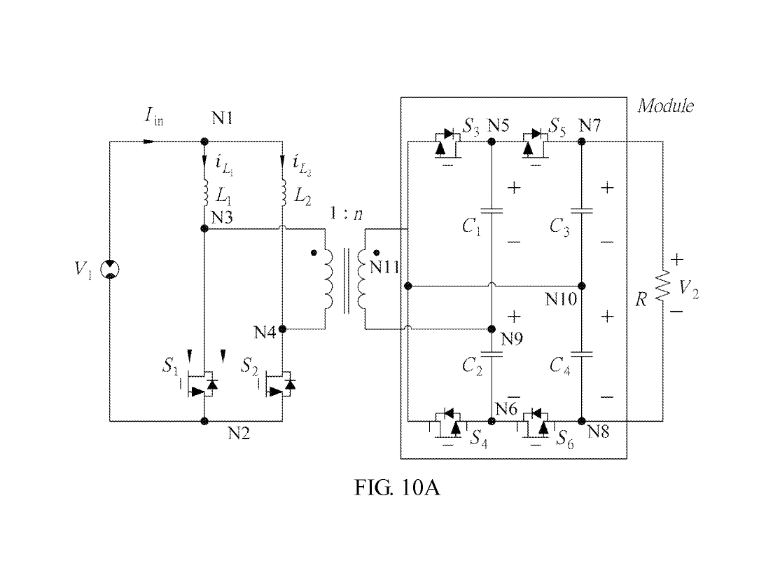

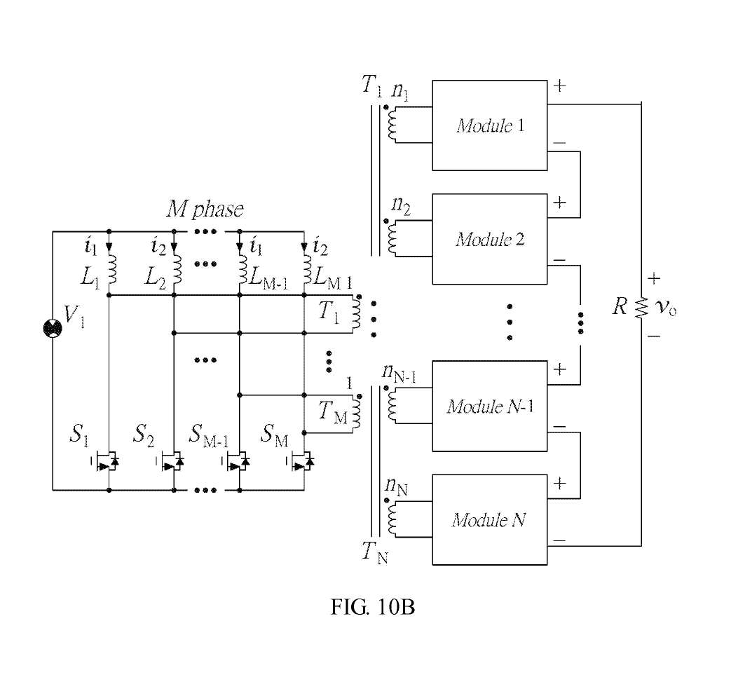

By means of the aforementioned boost and buck modes, the characteristics of a lower current ripple and the lower current stress of step-down side switch can be obtained, and the switching loss and conduction loss can be lowered by lower voltage stresses of the switch voltage so as to increase the efficiency of conversion circuit. Furthermore, the bidirectional dc-dc converter circuit of the present invention can be regarded as a module unit. With reference to FIG. 10a along with FIG. 10b for the basic configuration of a novel two-phase interleaved bidirectional converter of the present invention and the generalized configuration using module units for higher bidirectional conversion application of the present invention. By means of the module unit referred in FIG. 10a along with ways of connecting inputs of the multiple module units in parallel and outputs of the multiple module units in series, a combined bidirectional dc-dc converter circuit with better conversion efficiency referred in FIG. 10b can be generated.

To sum up, based on the capacitive voltage division principle, they are used to reduce the voltage stress of active switches as well as increasing the voltage conversion ratio. As a result, the present invention converter topology can possess lower switch voltage stress. This will allow one to choose lower voltage rating MOSFETs to reduce both switching and conduction losses. In addition, due to the charge balance of the blocking capacitors (C1 and C2), the converter also features automatic uniform current sharing characteristic of the interleaved phases without adding extra circuitry or complex control methods. The interleaved technology promotes the efficiency of power conversion and minimizes the conduction loss of inductor element as well as decrease the voltage stresses which can be endured by each switch, that is to say, the purpose of equalizing the inductor electric current by switch element of lower cost can be accomplished.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A bidirectional dc-dc converter system, comprising:
a first circuit having a first inductor, a second inductor, a first switch and a second switch, wherein the first switch and the second switch are used to control power flow in the first circuit;
a switched capacitor circuit having a first capacitor, a second capacitor, a third capacitor, a fourth capacitor, a first operating switch, a second operating switch, a third operating switch and a fourth operating switch are used to control power flow in the switched capacitor circuit, the first switch complementally driving with the first operating switch and the fourth operating switch, the second switch complementally driving with the second operating switch and the third operating switch; and
a transformer electrically coupling with the first circuit and the switched capacitor circuit, and generating a second current in the switched capacitor circuit according to a first current in the first circuit or generating the first current according to the second current;
wherein when the first circuit is supplied with a low voltage (V_{L}) to generate the first current, the second current generated by the transformer and the combination of switching the first switch and the second switch are used for entering a boost mode of the bidirectional dc-dc converter system, so that the first inductor and the second inductor or the first capacitor, the second capacitor, the third capacitor, and the fourth capacitor supply energy to a second output load of the switched capacitor circuit, and when the switched capacitor circuit is supplied with the high voltage (V_{H}) to generate the second current, the first current generated by the transformer and the combination of switching the first switch and the second switch are used for entering a buck mode of the bidirectional dc-dc converter system, so that the first inductor and the second inductor or the first capacitor, the second capacitor, the third capacitor, and the fourth capacitor supply energy to a first output load of the first circuit.

2. The bidirectional dc-dc converter system of claim 1, wherein the first switch, the second switch, the first operating switch, the second operating switch, the third operating switch, or the fourth operating switch comprises a parallel connection of a silicon control rectifier and a Schottky diode.

3. The bidirectional dc-dc converter system of claim 1, wherein the conduction duration (duty ratio) of the first switch, the second switch, the first operating switch, the second operating switch, the third operating switch, or the fourth operating switch directly affects output power of the bidirectional dc-dc converter system.

4. The bidirectional dc-dc converter system of claim 1, wherein a capacitance value of the first capacitor, the second capacitor, the third capacitor, or the fourth capacitor, and an inductor value of the first inductor or the second inductor mainly determine a time constant of circuit operation in the boost mode or the buck mode.

5. The bidirectional dc-dc converter system of claim 1, wherein the first switch performs a complemented operation with the first operating switch and the fourth operating switch by an inverter logical gate; the second switch performs complemented operation with the second operating switch and the third operating switch by an inverter logical gate.

6. A bidirectional dc-dc converter circuit, comprising:
a first circuit having a first inductor element, a second inductor element, a first device, a first switch element, a second switch element, a first electrical node, a second electrical node, a third electrical node and a fourth electrical node, wherein an end of the first inductor element, an end of the second inductor element, and an end of the first device are electrically coupled to the first electrical node, an end of the first switch element, an end of the second switch element, and the other end of the first device are electrically coupled to the second electrical node, the other end of the first inductor element and the other end of the first switch element are electrically coupled to the third electrical node, the other end of the second inductor element and the other end of the second switch element are electrically coupled to the fourth electrical node;
a switched capacitor circuit comprising a first operating switch element, a second operating switch element, a third operating switch element, a fourth operating switch, a first capacitor element, a second capacitor element, a third capacitor element, a fourth capacitor element, a fifth electrical node, a sixth electrical node, a seventh electrical node, an eighth electrical node, a ninth electrical node, a tenth electrical node, an eleventh electrical node, and a second device, wherein an end of the first operating switch element, an end of the first capacitor element and an end of the third operating switch element are electrically coupled to the fifth electrical node, an end of the second operating switch element, an end of the second capacitor element, and an end of the fourth operating switch element are electrically coupled to the sixth electrical node, the other end of the first operating switch element and the other end of the second operating switch element are electrically coupled to the eleventh electrical node, the other end of the third operating switch element, an end of the third capacitor element, and an end of the second device are electrically coupled to the seventh electrical node, the other end of the fourth operating switch element, an end of the fourth capacitor element, and the other end of the second device are electrically coupled to the eighth electrical node, the other end of the first capacitor element and the other end of the second capacitor element are electrically coupled to the ninth electrical node, the other end of the third capacitor element and the other end of the fourth capacitor element are electrically coupled to the tenth electrical node, the tenth electrical node is electrically coupled to the eleventh electrical node; and
a transformer having a primary side electrically coupled to the first circuit and a secondary side electrically coupled to the switched capacitor circuit, an end of the primary side electrically coupling to the third electrical node, the other end of the primary side electrically coupling to the fourth electrical node, an end of the secondary side electrically coupling to the eleventh electrical node, the other end of the secondary side electrically coupling to the ninth electrical node.

7. The bidirectional dc-dc converter circuit of claim 6, wherein the bidirectional dc-dc converter circuit is a module unit, and inputs of the multiple module units can be connected in parallel and the outputs of the multiple module units can be connected in series to generate the combined bidirectional dc-dc converter circuit of better conversion efficiency.

8. The bidirectional dc-dc converter circuit of claim 6, wherein when the first device is supplied with a lower voltage, entering a boost mode of the bidirectional dc-dc converter circuit through the combination of switching the first switch element and the second switch element, so that the first inductor element, the second inductor element, the first capacitor element, the second capacitor element, the third capacitor element, or the fourth capacitor element supplies energy to the second device to generate a boost effect.

9. The bidirectional dc-dc converter circuit of claim 6, wherein when the second device is supplied with a high voltage (V_{H}), entering a buck mode of the bidirectional dc-dc converter circuit through the combination of switching the first switch element and the second switch element, so that the first inductor element, the second inductor element, the first capacitor element, the second capacitor, the third capacitor element, or the fourth capacitor element supplies energy to the first device to generate a buck effect.

10. The bidirectional dc-dc converter circuit of claim 6, wherein the first switch element is complementally driven with the first operating switch element and the fourth operating switch element by an inverter logical gate; the second switch element is complementally driven with the second operating switch element and the third operating switch element by an inverter logical gate.
